(19) United States
(12) Patent Application Publication
(10) Pub. No.: US 2004/0196288 A1
(43) Pub. Date: Oct. 7, 2004

(54) Method and apparatus for generating vector font

(75) Inventor: Hee-Chul Han, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/682,429

(22) Filed: Oct. 10, 2003

(30) Foreign Application Priority Data
Apr. 1, 2003 (KR) 2003-20440

(51) Int. Cl. G06T 11/00

(52) U.S. Cl. 345/467

(57) ABSTRACT

Provided are a method and an apparatus for generating transformed fonts using a small amount of memory by transforming vector font data stored in the memory and outputting the transformed vector font data. As to certain identical characters in one text, it is decided to transform the respective identical characters to different degrees or to the same degree. Then, a degree of character transformation is set according to the decision. According to the set degree, the character is transformed by moving feature points, which form the character, upward, downward, to the left, or to the right.

### CROSS REFERENCE TO RELATED APPLICATION

This application claims the priority of Korean Patent Application No. 2003-20440, filed on 1 Apr. 2003, in the Korean Intellectual Property Office, the disclosure of which is incorporated herein in its entirety by reference.

### BACKGROUND OF THE INVENTION

1. Field of the Invention

The present invention relates to font generation, and more particularly, to a method and apparatus for generating transformed fonts while using a minimal amount of memory by gradually transforming vector font data, which is already stored in the memory and outputting the transformed vector font data.

2. Description of the Related Art

A character is formed of several lines or sides, and the lines or sides are formed of a number of dots. As a result, when a character is stored in a disk or displayed on a monitor, it should be processed in the unit of dots, lines, or sides. Here, a method of processing a character in the unit of dots is referred to as a bitmap font method whereas a method of processing a character in the unit of lines or sides is referred to as a vector font method.

A bitmap font represents a type of font in which a character is stored in a bitmap format expressed by a group of dots forming the character. When enlarging a character expressed in a bitmap format, the edges of the character take a stair-like appearance and are not smooth but uneven.

In contrast, in the vector font method, a character is expressed by a group of lines between dots forming the character. In other words, the vector font expresses characters of various shapes using command codes such as lines, circles, and arcs and coordinates, rather than using only a group of dots. Thus, it is easy for a user to increase or decrease a character size, adjust the relative horizontal and vertical size of the character, cast a shadow on the character, or slant the character to the right or left.

When the vector font is displayed on the monitor, it is necessary to extract feature points from a character region. Then, functions for moving between points, connecting points, and drawing a curve by connecting points are needed. As such, by forming a character using various functions, the vector font allows for a natural, enlarged or downsized character in contrast to the bitmap font that shows an unnatural stair shape. However, since the structure of the vector font varies with the functions used to form a character, storing or outputting the vector font requires a process that is more complex than one required by the bitmap font.

Until now, the bitmap font has been used in various electronic appliances. However, the use of bitmap fonts is being supplanted by a trend to use vector fonts, with the advent of new electronic appliances having high-performance chips and large-capacity memories.

Among the various kinds of vector fonts, a handwriting font is slightly different from actual handwriting, since actual handwriting does not always show the same shape for the same character even when a user desires to express the same character. For instance, when the user writes “ [symbol] ”, the former “ [symbol] ” is not always identical to the latter “ [symbol] ”. However, when using a specific font, the output characters “ [symbol] ” always have the same shape.

To output characters of various shapes, diverse fonts should be stored in a memory, and therefore, a memory having a large capacity proportional to the number of fonts is needed. In other words, it is possible to express a character of only one shape using just one font using the conventional vector font.

### SUMMARY OF THE INVENTION

The present invention provides a method and an apparatus for generating vector fonts, in which one provided vector font is transformed, thereby expressing characters of various shapes.

According to one aspect of the present invention, there is provided a method of generating a font. The method comprises (a) receiving font data and setting a degree of font transformation and (b) transforming the font by moving feature points, which form the font data, downward, upward, to the left, or to the right, according to the set degree.

The font is expressed using command codes that are formed of the feature points and implementation functions for moving to the feature points and forming a straight line or curve by connecting the feature points.

According to another aspect of the present invention, there is provided a method of generating a font. The method comprises (a) as to certain identical characters in one text, deciding to transform the respective identical characters to different degrees or to the same degree, (b) setting a degree of character transformation according to the decision, and (c) according to the set degree, transforming the character by moving feature points, which form the character, upward, downward, to the left, or to the right.

According to yet another aspect of the present invention, there is provided an apparatus of generating a font. The apparatus comprises a font transformation degree set unit and a font transformation unit. The font transformation degree set unit is input by a user according to the user's decision as to whether a certain kind of identical characters in one text will be transformed to the same degree or respective identical characters in one text will be transformed to different degrees and sets the degree of character transformation. The font transformation unit transforms a font by moving feature points of a character upward, downward, to the left, or to the right according to the set degree.

The apparatus further comprises a font data input unit, which receives font data to be displayed and an output unit, which outputs a transformed font formed by the font transformation unit.

According to yet another aspect of the present invention, there is provided a computer readable medium having embodied thereon a method of generating a font.

### BRIEF DESCRIPTION OF THE DRAWINGS

The above and other aspects and advantages of the present invention will become more apparent by describing in detail an exemplary embodiment thereof with reference to the attached drawings in which:

FIG. 1 illustrates a table showing command codes for processing a vector font and functions of the command codes;

FIG. 2 illustrates a curve when there are 4 control points;

FIG. 3 illustrates a character “ [symbol] ” expressed by the command codes of FIG. 1 and control points;

FIG. 4 illustrates a transformed character “ [symbol] ”;

FIG. 5 is a flowchart describing a method for generating a font according to the present invention;

FIG. 6 is a block diagram of an apparatus for generating a font according to the present invention; and

FIG. 7 is a view for explaining the degree of character transformation.

### DETAILED DESCRIPTION OF THE INVENTION

The present invention will now be described more fully with reference to the accompanying drawings, in which a preferred embodiment of the invention is shown.

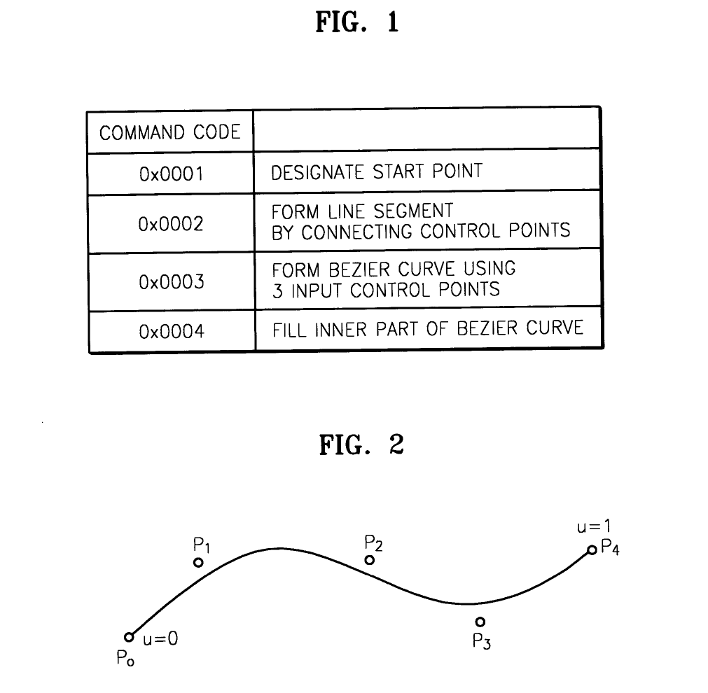

FIG. 1 illustrates a table showing command codes for processing a vector font and respective functions of the command codes.

A command code 0x0001 is used to designate a first start point or another start point when a character is formed. A command code 0x0002 is used to draw a line segment by connecting a start point or the end point of the previous line segment with a point that a user currently designates. A command code 0x0003 is used to draw a Bezier curve by receiving coordinates of 3 control points and connecting 3 control points, i.e., a start point, a middle point, and an end point. A command code 0x0004 is used to fill the inner part of the Bezier curve.

Referring to FIG. 1, the command code 0x0001 and a coordinate are needed to designate a coordinate of a start point or middle point and move to the designated coordinate. The command code 0x0002, a coordinate of a start point, i.e., (X0, Y0), and a coordinate of an end point, i.e., (X1, Y1) are needed to draw a straight line. The command code 0x0003 and 3 coordinates of a start point, a middle point, and an end point are needed to draw a curve.

The Bezier curve takes a curved shape by creating various functions using coordinates of input control points. The Bezier curve is obtained by the following Bezier function, and the degree of the Bezier function is smaller than the number of input control points by one degree.

$$B ( u ) = {\sum }_{k = 0}^{N} {P}_{k} \frac{N !}{k ! ( N - k ) !} {{u}^{k} ( 1 - u )}^{N - k} , for 0 \leq u \leq 1 \qquad ( 1 )$$

In other words, if 4 control points are input, a three-degree Bezier curve is obtained by a three-degree Bezier function. If 5 control points are input, a four-degree Bezier curve is obtained by a four-degree Bezier function. The number of control points used in the Bezier curve is not limited, but if the number of control points increases, a higher-degree multinomial function has to be calculated to obtain the Bezier curve.

FIG. 2 illustrates a curve when there are 4 control points.

Equation 1 is a continuous function for drawing a curve using N control points at different positions. When u is equal to 0, a curve starts with a first control point (k=0). Then, when u is equal to 1, the curve ends with an end control point (k=N). In other words, referring to FIG. 2, the first control point corresponds to a start point, the end control point corresponds to an end point, and the curve is always formed inside a polygon formed using control points and does not go out of the control points.

Equation 2 is a bending function and is used to form a curve.

$$\frac{N !}{k ! ( N - k ) !} {{u}^{k} ( 1 - u )}^{N - k} \qquad ( 2 )$$

The bending function is a multinomial function whose degree is smaller than the number of control points by one degree. Thus, if 3 control points are used, the Bezier curve is shaped like a two-degree parabola. If 4 control points are used, the Bezier curve is shaped like a three-degree curve. If the coordinates of the first control point is identical to the coordinates of the end control point, the Bezier curve is closed. If several control points are present at adjacent positions, the degree of bending of the Bezier curve increases toward adjacent positions. If the number of control points increases, a higher-degree function and a number of factorials have to be calculated. In this case, the entire Bezier curve is divided into several curve segments.

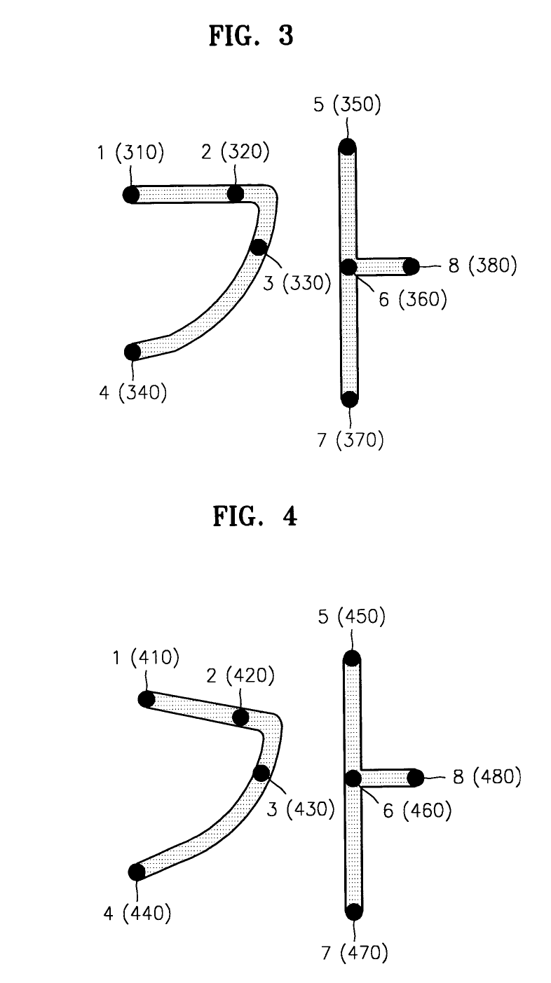

FIG. 3 illustrates a character “ [symbol] ” expressed by the command codes of FIG. 1 and control points.

The character “ [symbol] ” is expressed by 8 controls points 1-8 (310-380) and the command codes of FIG. 1. In other words, the character “ [symbol] ” is expressed by using the command code 0x0001 for designating a start point 1 (310), the command code 0x0002 for forming a straight line by connecting the start point 1 (310) to a control point 2 (320), the command code 0x0003 for forming a Bezier curve by connecting the control point 2 (320) to a control point 3 (330), the command code 0x0003 for forming a Bezier curve by connecting the control point 3 (32) to a control point 4 (34), the command code 0x0001 for designating a control 5 (350) as another start point, the command code 0x0002 for forming a straight line by connecting the control point 5 (350) to a control point 7(370), the command code 0x0001 for designating a control point 6 (360) as another start point, the command code 0x0002 for forming a straight line by connecting the control point 6 (360) to a control point 8 (380), and the command code 0x0004 for filling the inner part of the Bezier curve.

FIG. 4 illustrates a transformed character “ [symbol] ”.

As shown in FIG. 4, the transformed character “ [symbol] ” can be formed by moving a start point 1 (410) by a small degree. In addition, if a control point 2 (420) is moved, a Bezier curve, which is formed by connecting the control point 2 (420) to a control point 3 (430), is shaped different from that of FIG. 3. Thus, the character “ [symbol] ” of FIG. 4 looks different from FIG. 3. In other words, whenever a character is expressed, a shape of the character can be transformed by moving control points upward, downward, to the left, or to the right.

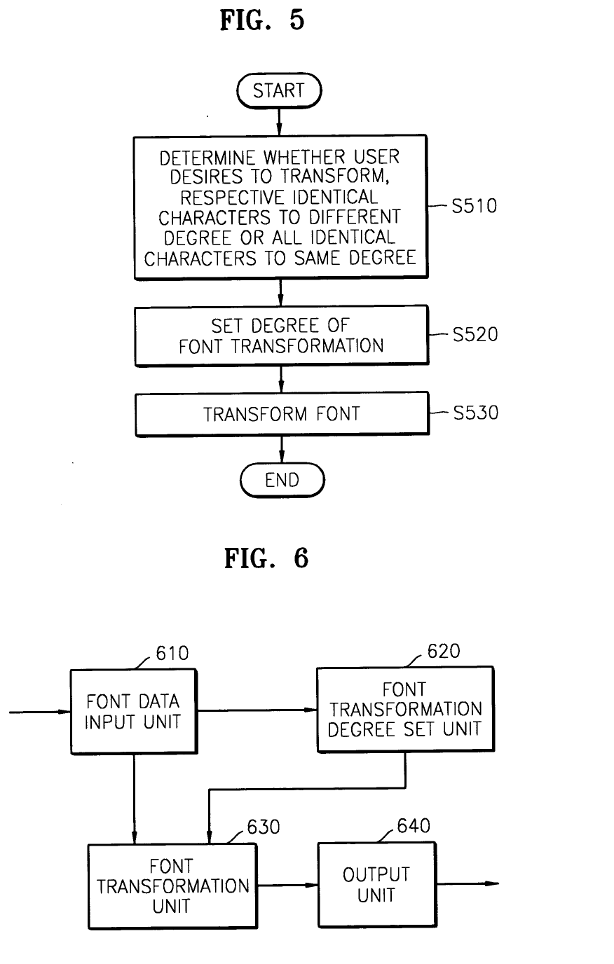

FIG. 5 is a flowchart describing a method of generating a font according to the present invention.

In the first step S510, it is determined whether a user desires to transform any instance of the instances of any character appearing several times in a text by a different degree of transformation or all of the instances of the character in the text by the same degree of transformation. For example, whenever the user desires to express a character “┐” “┐”, the character “┐” can be expressed in different shapes by transforming each instance of the character “┐” by a different degree. Also, all instances of the character “┐” in a text can be expressed in the same shape by transforming all instances of the character “┐” by the same degree of transformation.

Then, the degree of font transformation is set. In other words, in step S520, the amount of movement of control points (sometimes referred to as feature points), such as a start point or a middle point of a character or feature or portion of a character, is set for font transformation. If the user desires to transform each instance of a character in a text by different degrees of transformation, the amount of movement of the control points of the respective instances of the character varies within a predetermined range of movement. If the user desires to transform all instances of the character in the text by the same degree of transformation, then the amount of movement of the control points of all of the instances of the character is fixed to a predetermined degree.

In step S530, font transformation is carried out by moving the start point or the middle point according to the movement set in step S520. For instance, if it is determined that a start point or a middle point is moved by 2% of a font size along the y-axis direction, the y coordinate of a newly set start point corresponds to a value of the previous y coordinate −0.02 times the font size. If the user desires to transform instances of a character in a text into different shapes, each instance of the character is transformed according to the set amount of movement.

However, if the degree of movement is too large, the shape of the character may be transformed such that the transformed character is unreadable. Thus, the degree of movement of the control points should be set to a proper degree.

FIG. 6 is a block diagram of an apparatus for generating a font according to the present invention.

The apparatus of generating a font includes a font data input unit 610, a font transformation degree set unit 620, a font transformation unit 630, and an output unit 640.

The font data input unit 610 receives font data to be displayed. The font data includes the command codes of FIG. 1, several start points, and middle points. The font transformation degree set unit 620 is input by a user according to the user's preference as to whether all instances of a character in a text will be transformed to the same degree or whether some instances of the character in the text will be transformed by a different degree than other instances. Then, the font transformation degree set unit 620 sets the degree of font transformation. For example, whenever the user desires to express a character “┐”, the character “┐” can be expressed in different shapes by transforming each instance of the character “┐” by different degrees of transformation, or all instances of the character “┐” in the text can be expressed with the same shape by transforming all instances of the character “┐” by the same degree of transformation.

In other words, the degree of movement of the control points such as a start point or a middle point is set for font transformation. If the user desires to transform respective identical characters in one text to different degrees, the degree of movement of control points of each character varies within a predetermined range of the degree of movement. If the user desires to transform all instances of the character in the text to the same degree, the amount of movement of the control points of all characters is fixed to a predetermined degree.

The font transformation unit 630 carries out font transformation by moving the start point or the middle point according to the set degree of movement. For instance, it is determined that a start point or a middle point is moved by 2% of the font size along the y-axis direction, the y coordinate of a newly set start point corresponds to a value of the previous y coordinate −0.02 times the font size. If the user desires to transform respective identical characters in one text to different degrees, each character is transformed according to the set degree of movement.

However, if the degree of movement is too large, the shape of the character may be transformed such that the transformed character is unreadable. Thus, the degree of movement of the control points should be set to a proper degree.

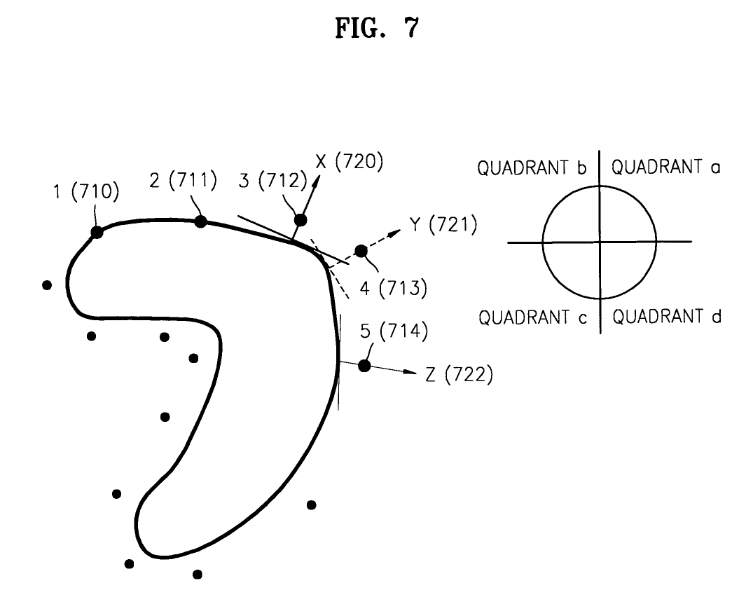

FIG. 7 is a view for explaining the degree of character transformation.

The degree of character transformation is set at control points 710-714 using vectors against the outer side of a character. A vector x (720) at a control point 3 (712) corresponds to quadrant a. A vector y (721) at a control point 4 (713) also corresponds to quadrant a. However, a vector z (722) at a control point 5 (714) corresponds to quadrant d. As such, a control point, at which some vectors correspond to quadrants different from those of the other vectors, has a degree of movement that is greater than those of other control points, thereby transforming the shape of a character by a greater degree. A control point, at which vectors correspond to the same quadrant, has an amount of movement that is smaller than those of other control points, thereby transforming the shape of a character by a smaller degree of transformation. Thus, it is possible to prevent the character from being transformed into an unreadable shape.

The output unit 640 outputs the transformed font.

The present invention may be embodied in a computer readable recording medium by using a computer readable code. The computer readable recording medium includes, but is not limited to storage media such as magnetic storage media (e.g., ROMs, floppy disks, hard disks, etc.), optically readable media (e.g., CD-ROMs, DVDs, etc.), and carrier waves (e.g., transmissions over the Internet). In addition, the computer readable recording medium may be distributed over a computer system connected through a network. The computer readable code can be stored and implemented in the computer readable recording medium.

According to the present invention, it is possible to generate the appearance of various fonts by transforming one vector font.

In addition, since various fonts can be obtained by transforming one vector font, a user can avoid an excess of the same font that would require a large-capacity memory for storing various fonts.

While illustrative example of the present invention used Korean character, it will be recognized that the invention could easily be used for other characters, letters, numerals, and symbols, including those of the Latin, Greek, Cyrillic, Arabic, Hebrew, Chinese, and Japanese alphabets, Arabic and Roman numerals and other types of symbols and notation systems. The use of the terms “character” herein may include a symbol of any of the foregoing.

While the present invention has been particularly shown and described with reference to an exemplary embodiment thereof, it will be understood by those of ordinary skill in the art that various changes in form and details may be made therein without departing from the spirit and scope of the invention as defined by the appended claims and their equivalents.

What is claimed is:

1. A method of generating a font, the method comprising:
(a) receiving font data for a character, and setting a degree of font transformation; and
(b) transforming the font for the character by moving a set of transforming feature points of a plurality of feature points comprising the font data for the character downward, upward, to the left, or to the right, according to the set degree of font transformation, and outputting a result of the font transformation.

2. The method of claim 1, wherein the font is expressed using command codes at the plurality of feature points and implementation functions forming at least one of a straight line and a curve connecting the plurality of feature points, and moving the set of transforming feature points of the plurality of feature points according to the set degree of font transformation.

3. The method of claim 2, wherein the curve is a Bezier curve.

4. The method of claim 2, wherein the font is a vector font.

5. The method of claim 1, wherein the degree of font transformation is set to a predetermined percentage of a font size of the font.

6. The method of claim 1, step (b) further comprising moving a first feature point of the set of transforming feature points of the plurality of feature points by a small amount of movement when a second feature point of the set of transforming feature points adjacent to the first feature point has a vector corresponding to the same quadrant as the vector of the first feature point, and in other cases, moving the first feature point by a large amount of movement.

7. A method of generating a font, the method comprising:
(a) deciding whether to transform all instances of a plurality of instances of a character in a text by an identical degree of font transformation or to transform an instance of the plurality of instances of the character by a degree of font transformation different from other instances of the plurality of instances; and
(b) setting the degree of font transformation for each instance of the plurality of instances of the character according to the decision; and
(c) according to the set degree of font transformation, transforming the font of the plurality of instances of the character by moving upward, downward, to the left, or to the right a set of transforming features points of a plurality of feature points forming the character, and outputting a result of the transformation.

8. The method of claim 7, step (b) further comprising, if, based on user input, the decision is made to transform the instance of the plurality of instances of the character by a degree of font transformation different from other instances of the plurality of instances of the character, setting the degree of font transformation for each instance of the plurality of instances of the character, and in other cases, fixing the degree of font transformation to a predetermined degree.

9. The method of claim 7, wherein the character is expressed using command codes at the plurality of feature points forming the character and by implementation functions for forming at least one of a straight line and a curve by connecting the plurality of feature points, and moving the set of transforming feature points of the plurality of feature points, according to the degree of font transformation.

10. The method of claim 9, wherein the curve formed by connecting feature points of the plurality of feature points is a Bezier curve.

11. The method of claim 9, wherein the character is expressed by a vector font.

12. The method of claim 7, wherein the degree of font transformation is set to a predetermined percentage of a size of the character.

13. The method of claim 7, wherein a first feature point of the set of transforming feature points of the plurality of feature points forming the character is moved by a small amount, when a second feature point of the set of transforming feature points has a vector in a quadrant corresponding to the vector of the first feature point, and the first feature point is moved by a large amount in other cases.

14. A font generation apparatus, the apparatus comprising:
a font transformation degree set unit configured to receive user input to make a determination to transform all instances of a plurality of instances of a character in a text by a substantially identical degree of font transformation or to transform an instance of the plurality of instances by a degree of font transformation different from the degree of font transformation for other instances of the plurality of instances, and to set, accordingly, the degree of font transformation for the plurality of instances; and
a font transformation unit configured to transform the font of the plurality of instances of the character by moving a set of transforming feature points of a plurality of feature points of the character upward, downward, to the left, or to the right, according to the set degree of font transformation provided by the font transformation degree set unit, and to output a result of the font transformation.

15. The apparatus of claim 14, further comprising a font data input unit configured to receive font data to be displayed.

16. The apparatus of claim 14, wherein the font is expressed using command codes at the plurality of feature points and implementation functions for forming one of a straight line and a curve connecting the plurality of feature points, and moving the set of transforming feature points of the plurality of feature points according to the degree of font transformation.

17. The apparatus of claim 16, wherein the font is a vector font, and the curve formed is a Bezier curve.

18. The apparatus of claim 14, wherein, when a user input is received indicating the degree of font transformation for an instance of the plurality of instances different from the degree of font transformation for other instances of the plurality of instances, the font transformation degree set unit sets the degree of font transformation for each instance of the plurality of instances at random within a predetermined range of degrees, and in other cases, sets the degree of character transformation to a predetermined degree.

19. The apparatus of claim 18, wherein the degree of font transformation is set to a predetermined percentage of a character size.

20. The apparatus of claim 14, wherein the font transformation unit moves a first feature point of the set of transforming feature points of the plurality of feature points forming the character by a small amount, when a second feature point of the set of transforming feature points has a vector in a quadrant corresponding to the vector of the first feature point, and in other cases, moves the first feature point by a large amount.

21. A computer readable medium having embodied thereon a method of generating a font, the method comprising:
(a) receiving font data for a character, and setting a degree of font transformation; and
(b) transforming the font for the character by moving feature points of a plurality of feature points comprising the font data downward, upward, to the left, or to the right, according to the set degree of font transformation, and outputting a result of the font transformation.

22. A computer readable medium having embodied thereon a method of generating a font, the method comprising:
(a) deciding whether to transform all instances of a plurality of instances of a character in a text by an identical degree of font transformation or to transform an instance of the plurality of instances of the character by a degree of font transformation different from other instances of the plurality of instances of the character; and
(b) setting the degree of font transformation for each instance of the plurality of instances of the character, according to the decision; and
(c) according to the set degree of font transformation, transforming the font for the plurality of instances of the character by moving upward, downward, to the left, or to the right a set of transforming features points of a plurality of feature points forming the character, and outputting a result of the transformation.
